(19) United States
(12) Patent Application Publication
(10) Pub. No.: US 2025/0063103 A1
(43) Pub. Date: Feb. 20, 2025

(54) METHOD, APPARATUS, ELECTRONIC DEVICE AND STORAGE MEDIUM FOR SIGNALING NEGOTIATION OR DATA COMMUNICATION

(71) Applicant: Douyin Vision Co., Ltd, Beijing (CN)

(72) Inventors: Jinyan WANG, Beijing (CN); Jianping CHEN, Beijing (CN)

(21) Appl. No.: 18/801,054

(22) Filed: Aug. 12, 2024

(30) Foreign Application Priority Data
Aug. 16, 2023 (CN) 202311034512.5

(51) Int. Cl. H04L 67/563; H04L 9/40; H04L 43/0811

(52) U.S. Cl. CPC H04L 67/563; H04L 43/0811; H04L 63/0428

(57) ABSTRACT

The embodiment of the disclosure provides a method, apparatus, electronic device and storage medium for signaling negotiation or data communication. The signaling negotiation method includes: generating, in response to a signaling request sent by a client, a signaling context corresponding to the signaling request, and storing the signaling context; in response to receiving redirection address information of a redirection server corresponding to the signaling request, generating a target signaling response message based on the redirection address information and negotiation address information of the signaling negotiation server; and feeding back the target signaling response message to the client, to enable the client to detect connectivity based on the redirection address information, and obtain target data corresponding to the signaling request based on a result of detection. With the technical solution, various network protocols may be adapted, and the signaling interaction time in the redirection scene is reduced.

### CROSS-REFERENCE

The present application claims priority to Chinese Patent Application No. 202311034512.5, filed on Aug. 16, 2023 and entitled “METHOD, APPARATUS, ELECTRONIC DEVICE AND STORAGE MEDIUM FOR SIGNALING NEGOTIATION OR DATA COMMUNICATION”, the entirety of which is incorporated herein by reference.

### FIELD

Embodiments of the disclosure relate to data communication technologies, and in particular, to a method, an apparatus, an electronic device, and a storage medium for signaling negotiation or data communication.

### BACKGROUND

In a network service scenario, when faced with a large number of concurrent users accessing, it is difficult for a single server to bear a large number of concurrent requests because of its limited processing capacity. Generally, concurrent requests are distributed to multiple servers for processing through load balancing. A redirection technology is one of the common solutions for implementing load balancing, and it is a technology that a server redirects a data obtaining request of a client to another server.

In the related art, redirection of data requests is generally achieved based on a redirection function of Hypertext Transfer Protocol (HTTP). That is, the HTTP request is redirected from the network address of the current request to another network address according to the status code and the response header of the HTTP response.

However, using HTTP redirection requires two signaling negotiation processes, which increases the data obtaining time. Moreover, in some network service scenarios, for example, in an ultra-low latency live streaming, a protocol for signaling negotiation often has no standard specification. When other protocols other than HTTP are used, the inability to use HTTP's redirection function may result in longer response time or even failed response to data requests.

### SUMMARY

The disclosure provides a method, apparatus, electronic device, and storage medium for signaling negotiation or data communication, so as to realize redirection of a data obtaining request.

According to a first aspect, the embodiment of this disclosure provides a signaling negotiation method, applied to a signaling negotiation server, comprising:
generating, in response to a signaling request sent by a client, a signaling context corresponding to the signaling request, and storing the signaling context;
in response to receiving redirection address information of a redirection server corresponding to the signaling request, generating a target signaling response message based on the redirection address information and negotiation address information of the signaling negotiation server; and
feeding back the target signaling response message to the client, to enable the client to detect connectivity based on the redirection address information, and obtain target data corresponding to the signaling request based on a result of detection.

According to a second aspect, the embodiment of this disclosure provides a data communication method, applied to a redirection server, comprising:
receiving a connection detection request sent by a client based on redirection address information of a redirection server, wherein the connection detection request comprises negotiation address information of a signaling negotiation server, and the signaling negotiation server stores a signaling context corresponding to the signaling request;
in response to the negotiation address information being inconsistent with the redirection address information, initiating a context obtaining request to the signaling negotiation server based on the negotiation address information to obtain the signaling context from the signaling negotiation server; and
generating, after obtaining the signaling context, a connection response message for the connection detection request, and sending the connection response message and target data corresponding to the signaling request to the client based on the signaling context.

According to a third aspect, the embodiment of this disclosure provides a signaling negotiation apparatus, configured in a signaling negotiation server, comprising:
a signaling request receiving module configured to generate, in response to a signaling request sent by a client, a signaling context corresponding to the signaling request, and store the signaling context;
a response message generating module configured to, in response to receiving redirection address information of a redirection server corresponding to the signaling request, generate a target signaling response message based on the redirection address information and negotiation address information of the signaling negotiation server; and
a response message sending module configured to feed back the target signaling response message to the client, to enable the client to detect connectivity based on the redirection address information, and obtain target data corresponding to the signaling request based on a result of detection.

According to a fourth aspect, the embodiment of this disclosure provides a data communication apparatus, applied to a redirection server, comprising:
a detection requesting module configured to receive a connection detection request sent by a client based on redirection address information of a redirection server, the connection detection request comprising negotiation address information of a signaling negotiation server, and the signaling negotiation server storing a signaling context corresponding to the signaling request;
a context obtaining module configured to, in response to the negotiation address information being inconsistent with the redirection address information, initiate a context obtaining request to the signaling negotiation server based on the negotiation address information to obtain the signaling context from the signaling negotiation server; and
a connection responding module configured to generate, after obtaining the signaling context, a connection response message for the connection detection request, and send the connection response message and target data corresponding to the signaling request to the client based on the signaling context.

According to a fifth aspect, the embodiment of this disclosure further provides an electronic device, comprising:
one or more processors; and
a storage device storing one or more programs,
the one or more programs, when executed by the one or more processors, causing the one or more processors implement the signaling negotiation method and/or the data communication method according to any embodiment of this disclosure.

According to a sixth aspect, the embodiment of this disclosure further provides a storage medium comprising computer-executable instructions, wherein the computer-executable instructions, when executed by a computer processor, perform the signaling negotiation method and/or the data communication method according to any embodiment of this disclosure.

According to the technical solution of embodiments of this disclosure, firstly, in response to a signaling request sent by a client, a signaling context corresponding to the signaling request is generated, and the signaling context is stored, therefore feedback data corresponding to the signaling request is determined based on the signaling context. Then, in response to receiving redirection address information of a redirection server corresponding to the signaling request, a target signaling response message is generated based on the redirection address information and negotiation address information of the signaling negotiation serve. The target signaling response message is fed back to the client, to enable the client to detect connectivity based on the redirection address information, and obtain target data corresponding to the signaling request based on a result of detection. The redirection address information and the negotiation address information may be obtained at the same time in one signaling request, so that the connection between the redirection server and the client may be established based on the redirection address information and the negotiation address information in the data phase. That is, the connection with redirection server may be established in one signaling request. The technical problem that in the related art, the redirection function needs to be realized according to a specific protocol and the request response efficiency is reduced due to redirection is solved. Various network protocols may be adapted, the dependency of redirection on a specific protocol is overcome. Further, the application scene of redirection is expanded, and the signaling interaction time in the redirection scene is reduced.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and elements and components are not necessarily drawn to scale.

FIG. 1 is a schematic flowchart of a signaling negotiation method according to an embodiment of the present disclosure;

FIG. 2 is a schematic flowchart of a signaling negotiation method according to an embodiment of the present disclosure;

FIG. 3 is a schematic flowchart of a signaling negotiation method in a data communication scenario implemented based on WebRTC according to an embodiment of the present disclosure;

FIG. 4 is a schematic flowchart of a data communication method according to an embodiment of the present disclosure;

FIG. 5 is a schematic flowchart of another data communication method according to an embodiment of the present disclosure;

FIG. 6 is a schematic structural diagram of a signaling negotiation apparatus according to an embodiment of the present disclosure;

FIG. 7 is a schematic structural diagram of a data communication apparatus according to an embodiment of the present disclosure; and

FIG. 8 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein. Rather, these embodiments are provided for a more thorough and complete understanding of the present disclosure. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprises” and variation thereof are open-ended, i.e., “comprises but not limited to”. The term “based on” means “based at least in part on”. The term “one embodiment” means “at least one embodiment”; the term “another embodiment” means “at least one further embodiment”; and the term “some embodiments” means “at least some embodiments”. The relevant definition of other terms will be given below.

It should be noted that terms such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that they means “one or more” unless the context clearly indicates otherwise.

The names of messages or information interacted between a plurality of devices in embodiments of the present disclosure are for illustrative purposes only, and are not intended to limit the scope of such messages or information.

It can be understood that, before the technical solutions disclosed in the embodiments of the present disclosure are used, the types, the usage scope, the usage scenario and the like of personal information involved in the present disclosure should be notified to the user in an appropriate manner according to the relevant laws and regulations and the authorization of the user must be acquired.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information, such as an electronic device, application program or storage medium.

As an optional but non-limiting implementation, in response to receiving the active request of the user, the manner of sending the prompt information to the user may be, for example, a pop-up window, and the prompt information may be presented in text in the pop-up window. In addition, the pop-up window may further carry a selection control for the user to select “agree” or “disagree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

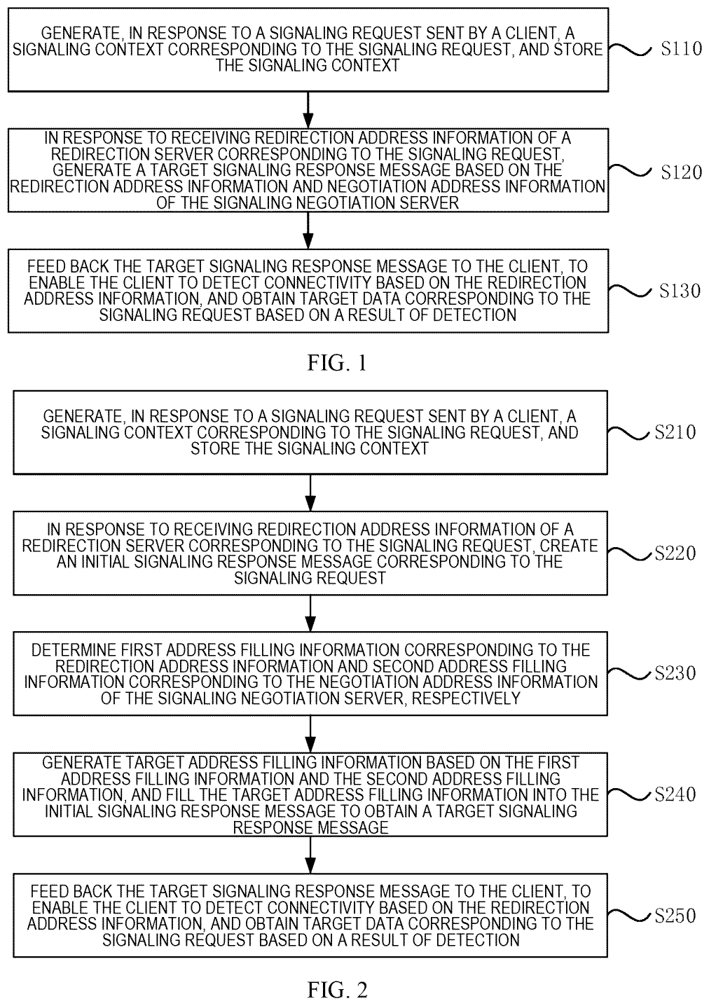

FIG. 1 is a schematic flowchart of a signaling negotiation method according to an embodiment of the present disclosure. The embodiment of the present disclosure is applicable to a situation in which a signaling request is redirected in a signaling phase, and is particularly applicable to a distributed system under a load balancing mechanism. The method may be executed by a signaling negotiation apparatus, which may be implemented in the form of software and/or hardware, optionally, by an electronic device. The electronic device may be a signaling negotiation server or an upper layer management device of the signaling negotiation server, or the like. A signaling negotiation server may be understood as a server that responds to a signaling request during a signaling negotiation phase of data communication.

As shown in FIG. 1, the method in this embodiment may specifically comprise:

S110: generate, in response to a signaling request sent by a client, a signaling context corresponding to the signaling request, and store the signaling context.

The client may be understood as the initiator of signaling requests. Specifically, the client may be an application program that corresponds to the server side, has data communication capabilities, and provides local services to users. The signaling request may be a data communication request initiated based on a service in the client, for example, a signaling request for live streaming pulling initiated based on a live streaming client.

The signaling context may be understood as context information used to obtain target data corresponding to the signaling request. For example, the signaling context may include verification information and data information. The verification information is used to verify in the connectivity detection phase, which may specifically comprise negotiation address information of the signaling negotiation server. The data information may be understood as information associated with to-be-obtained target data, for example, the data information may include, but is not limited to, at least one of information such as a data format, a data version, and a data obtaining path.

Specifically, the client may generate the signaling request based on receiving the communication trigger operation. Then, the signaling request is sent to the server side. The server side may allocate server for the signaling request, that is, determine the signaling negotiation server. Then the signaling request may be sent to the signaling negotiation server. After receiving the signaling request sent by the client, the signaling negotiation server generates a signaling context corresponding to the signaling request. The generating the signaling context corresponding to the signaling request comprises, but is not limited to, obtaining the data format supported by the client and the data format supported by the server to determine the data format in the signaling context. Specifically, the data format supported by both the client and the server may be used as the data format in the signaling context. After the signaling context is generated, the signaling context is stored in the local storage space of the signaling negotiation server, so that the subsequent data phase uses the signaling context to obtain the target data corresponding to the signaling request.

S120: in response to receiving redirection address information of a redirection server corresponding to the signaling request, generate a target signaling response message based on the redirection address information and negotiation address information of the signaling negotiation server.

The redirection address information may be understood as information used to indicate an Internet Protocol address of the redirection server. The redirection address information may be a virtual Internet protocol address corresponding to the redirection server, or may be a public network Internet protocol address of the redirection server. The negotiation address information of the signaling negotiation server is a public network Internet protocol address of the signaling negotiation server, or a virtual Internet protocol address and an inter network Internet protocol address corresponding to the signaling negotiation server.

Optionally, the target signaling response message is generated based on the original redirection address information and the original negotiation address information of the signaling negotiation server; or the redirection address information and the negotiation address information of the signaling negotiation server are respectively processed, and the target signaling response message is generated based on the processed redirection address information and the negotiation address information.

In this embodiment of the disclosure, after the signaling request is received, it may be firstly determined whether redirection is required. If the redirection is required, the redirection address information of the redirection server corresponding to the signaling request is determined. As an optional implementation of the embodiments of the disclosure, specifically, after receiving the signaling request, the signaling negotiation server queries a scheduling system of the server side whether redirection is required. The scheduling system determines whether redirection is required based on a mechanism such as load balancing. If it is determined that redirection is required, the redirection server may be matched, the redirection address information of the redirection server may be obtained, and the redirection information may be fed back to the signaling negotiation server. After the redirection address information of the redirection server fed back by the scheduling system is received, the target signaling response message is generated based on the redirection address information and the negotiation address information of the signaling negotiation server.

After the signaling request is received, the target signaling response message corresponding to the signaling request needs to be generated to notify the server of the negotiation result. Different from the related art, in which only the negotiation address information corresponding to the signaling negotiation server is added in the target signaling response message, the target signaling response message in the embodiment of the present disclosure comprises both the redirection address information and the negotiation address information of the signaling negotiation server. The redirection address information may be used for a subsequent data phase to establish a connection with the redirection server. The negotiation address information of the signaling negotiation server may provide data support for the redirection server to obtain the signaling context, to ensure a smooth data communication.

S130: feed back the target signaling response message to the client, to enable the client to detect connectivity based on the redirection address information, and obtain target data corresponding to the signaling request based on a result of detection.

Optionally, the signaling negotiation server may directly feed back the target signaling response message to the client; or the signaling negotiation server directly feeds back the target signaling response message to the client through a proxy server (for example, a server provided with a four-layer load balancing mechanism).

Specifically, after receiving the target signaling response message, the client may enter the data phase. A connection detection request is initiated based on the redirection address information in the target signaling response message. Further, when the detection response message corresponding to the connection detection request is received, it is determined that the communication channel between the client and the server is successfully established, the data communication with the server may be performed, and the target data corresponding to the signaling request is obtained from the server.

According to the technical solution of the embodiment of the disclosure, firstly, in response to a signaling request sent by a client, a signaling context corresponding to the signaling request is generated, and the signaling context is stored, therefore feedback data corresponding to the signaling request is determined based on the signaling context. Then, in response to receiving redirection address information of a redirection server corresponding to the signaling request, a target signaling response message is generated based on the redirection address information and negotiation address information of the signaling negotiation serve. The target signaling response message is fed back to the client, to enable the client to detect connectivity based on the redirection address information, and obtain target data corresponding to the signaling request based on a result of detection. The redirection address information and the negotiation address information may be obtained at the same time in one signaling request, so that the connection between the redirection server and the client may be established based on the redirection address information and the negotiation address information in the data phase. That is, the connection with redirection server may be established in one signaling request. The technical problem that in the related art, the redirection function needs to be realized according to a specific protocol and the request response efficiency is reduced due to redirection is solved. Various network protocols may be adapted, the dependency of redirection on a specific protocol is overcome. Further, the application scene of redirection is expanded, and the signaling interaction time in the redirection scene is reduced.

FIG. 2 is a schematic flowchart of another signaling negotiation method according to an embodiment of the present disclosure. Based on the foregoing embodiment, the technical solution of this embodiment further details a process of generating a signaling response message. Optionally, generating the target signaling response message based on the redirection address information and the negotiation address information of the signaling negotiation server comprises: creating an initial signaling response message corresponding to the signaling request; determining first address filling information corresponding to the redirection address information and second address filling information corresponding to the negotiation address information of the signaling negotiation server, respectively; and generating target address filling information based on the first address filling information and the second address filling information, and filling the target address filling information into the initial signaling response message to obtain a target signaling response message. For a specific implementation, reference may be made to the description of this embodiment. Technical features that are same as or similar to the foregoing embodiments are not repeated herein.

As shown in FIG. 2, the method in this embodiment may specifically comprise:

S210: generate, in response to a signaling request sent by a client, a signaling context corresponding to the signaling request, and store the signaling context.

S220: in response to receiving redirection address information of a redirection server corresponding to the signaling request, create an initial signaling response message corresponding to the signaling request.

The initial signaling response message may be understood as a pre-constructed model of a signaling response message. The initial signaling response message comprises candidate addresses and verification information. Generally, the parameter value corresponding to the candidate address and the verification information in the initial signaling response message is an initial parameter set by the template or is empty, to be filled in after determination by the server.

It may be understood that the specific format and content of the initial signaling response message are related to the technology used by the signaling negotiation, and the specific format and content thereof are not limited herein.

S230: determine first address filling information corresponding to the redirection address information and second address filling information corresponding to the negotiation address information of the signaling negotiation server, respectively.

The first address filling information may be understood as information indicating redirection address information, which is to be written into the initial signaling response message.

As an optional implementation of the embodiments of the disclosure, the redirection address information may be taken as the first address filling information corresponding to the redirection address information. This technical solution is suitable for the relatively safe network environment, and the benefit that the redirection address information is directly taken as the first address filling information is that the redirection address information does not need to be subjected to secondary processing, which facilitates the rapid generation of target signaling response message based on the initial signaling response message.

Considering the fact that there may be a risk of a malicious attack or a malicious application after information leakage during information transmission. As another optional implementation of the embodiments of the disclosure, the redirection address information may be encrypted to obtain the first address filling information. By adopting the technical solution, the redirection address information may be converted into the encryption information, which may reduce the risk that the redirection address information is directly used after being intercepted, and improve the information security of the redirection address information.

In the embodiments of the present disclosure, there may be a plurality of manners of encryption the redirection address information. Optionally, the redirection address information is encrypted based on a predetermined encryption algorithm. The predetermined encryption algorithm may be one or more of a symmetric encryption algorithm, an asymmetric encryption algorithm, and a hash encryption algorithm. Which encryption algorithm is used to encrypt the redirection address information may be set according to actual requirements, the used specific encryption algorithm is not limited herein.

In order to avoid the risk of decrypting the encrypted information of the redirect address information through decryption algorithms to obtain the redirect address information, it is not necessary to add the redirect address information as the first address filling information in the initial response message. For example, other information that has a mapping relationship with the redirection address information may be taken as the first address filling information. As still another optional implementation of the embodiments of the disclosure, first address identification information corresponding to the redirection address information is determined, and the first address identification information is taken as the first address filling information. By adopting the technical solution, the redirection address information may be replaced by the first address identification information. Thus the risk of resolving the redirection address information by intercepting the target response message is avoided, the information security of the redirection address information is fully ensured, and the information security of the redirection server is ensured.

Optionally, the determining the first address identification information corresponding to the redirection address information comprises: obtaining predetermined first address identification information corresponding to the redirection address information; or converting the redirection address information into the first address identification information based on a predetermined identification conversion interface.

Optionally, address identification information is set for the server address information of each server in advance, and a correspondence between the server address information and the address identification information is established. Further, the address identification information corresponding to the redirection address information is query as the first address identification information based on the correspondence. It should be noted that the address identification information may be part of information of the redirection address information, or other information different from the redirection address information. For example, the address identification information may be a server identifier corresponding to the server, for example, a server number.

The identification conversion interface may be understood as a function of converting the input redirection address information into other information according to a predetermined conversion rule. In the embodiment of the present disclosure, the redirection address information may be input into the identification conversion interface, after being processed via the identification conversion interface, the converted information is output, and the converted information is taken as the first address identification information. It may be understood that the conversion rule may be set according to actual requirements, which is not specifically limited herein.

Further, the identification conversion interface may be further configured to reversely convert the first address identification information into redirection address information, so as to reversely parsing out the redirection address information. Alternatively, the first address identification information may be reversely converted into the redirection address information through a predetermined address conversion interface. Optionally, when the address conversion interface is in an valid state, it will be added to the first address identification information as the first address filling information to be filled into the initial response message. When the address conversion interface is in an invalid state, it will be added to the encrypted information obtained by encrypting the redirection address information to be filled into the initial response message. This arrangement has the advantage of ensuring smooth obtaining of redirection address information.

In some application scenarios, the first address filling information corresponding to the redirection address information may be determined in combination with the foregoing manner. For example, whether the identification conversion interface is valid may be detected, and if valid, the identification conversion interface is used to obtain the first address filling information; if not, the first address filling information obtained after encryption processing is used, or the redirection address information is used as the first address filling information. Specifically, in response to the identification conversion interface being in a valid state, in response to the identification conversion interface being in a valid state, the redirection address information is converted into first address identification information based on the identification conversion interface, and the first address identification information is taken as the first address filling information; and in response to the identification conversion interface being in an invalid state, the redirection address information is encrypted to obtain the first address filling information. By adopting the technical solution, double guarantee is provided for information security of the redirection address information, the smooth progress of the signaling negotiation process is ensured, and the information security of the redirection address information is improved.

Similarly, determining the second address filling information corresponding to the negotiation address information of the signaling negotiation server comprises: encrypting the negotiation address information to obtain the second address filling information; and/or determining second address identification information corresponding to the negotiation address information, and taking the second address identification information as the second address filling information.

Further, the determining the second address identification information corresponding to the negotiation address information comprises: obtaining predetermined second address identification information corresponding to the negotiation address information; or converting the negotiation address information into the second address identification information based on a predetermined identification conversion interface.

Based on above, determining the second address filling information corresponding to the negotiation address information may comprise: in response to the identification conversion interface being in a valid state, converting the negotiation address information into second address identification information based on the identification conversion interface, and taking the second address identification information as the second address filling information; and in response to the identification conversion interface being in an invalid state, encrypting the negotiation address information to obtain the second address filling information.

Similarly, the identification conversion interface may be further configured to reversely convert the second address identification information into negotiation address information, so as to reversely parsing out the negotiation address information. Alternatively, the second address identification information may be reversely converted into the negotiation address information through a predetermined address conversion interface. Optionally, when the address conversion interface is in a valid state, it will be added to the second address identification information as the second address filling information to be filled into the initial response message. When the address conversion interface is in an invalid state, it will be added to the encrypted information obtained by encrypting the negotiation address information to be filled into the initial response message. This arrangement has the advantage of ensuring smooth obtaining of negotiation address information.

It should be noted that, the identification conversion interface used to convert the negotiation address information into the second address identification information and the identification conversion interface used to convert the redirection address information into the first address identification information may be same or different. Similarly, the address conversion interface used to convert the second address identification information into the negotiation address information and the address conversion interface used to convert the first address identification information into the redirection address information may be same or different.

S240: generating target address filling information based on the first address filling information and the second address filling information, and filling the target address filling information into the initial signaling response message to obtain a target signaling response message.

The target address filling information is to be written into information indicating the redirection address information and the negotiation address information of the initial signaling response message.

For example, the target address filling information comprises candidate address information and target verification information. Specifically, generating the target address filling information based on the first address filling information and the second address filling information comprises: taking the first address filling information as candidate address information; and joining the second address filling information and verification association information in a predetermined order to obtain target verification information, wherein the verification association information comprises a validation random number configured to recognize validity of a network communication protocol.

Optionally, the verification association information may further comprise connection identification information and/or a signaling request protocol type. The connection identification information may be used to distinguish a single signaling request. For example, in response that a live streaming pulling signaling request is received, the connection identification information is used to distinguish a single live streaming pulling. The signaling request protocol type determines whether a security protocol is required when the signaling context is requested. In the embodiments of the present disclosure, the joining manner of the verification information may be set according to actual requirements, which is not specifically limited herein.

Taking a data communication scenario implemented based on WebRTC (Web Real-Time Communication) as an example, for example, a millisecond low latency live streaming technology implemented based on WebRTC, RTM (Real-Time Media). WebRTC communication is generally divided into two phases: a signaling phase and a data phase. In the signaling phase, the client and the server exchange signaling information, and the signaling information is usually described by an SDP (Session Description Protocol), comprising content such as a session description and a candidate address (ICE Candidate), where the candidate address is a combination of an IP address and a port number allocated by the server for media transmission. In the data phase, the client first performs an ICE (Interactive Connectivity Establishment) connection, detects the server candidate address received in the signaling phase, to ensure that the accessed network is connected, thereby establishing the data transmission channel.

The signaling negotiation server providing the signaling service saves the context of the signaling negotiation, fills the outer network IP/VIP of the redirection server into the candidate address a=candidate row of the initial signaling response message SDP answer returned to the client, and fills the second address identification information of the server or the encrypted outer network IP/VIP (Virtual IP Address) and the inner network IP into the verification information a=ice-ufrag row to obtain the target signaling response message.

The ice-ufrag stores negotiation address information of the signaling negotiation service, and may be understood as verification information in the target response message. In the embodiment of the present disclosure, the content of the ice-ufrag may be customized. For example, the first byte of ice-ufrag may be identified with a special character @, and the second byte may be used to identify the version of ufrag. According to the specific content of the token in the TLV (Type-Length-Value) manner, the token is used as the ice-ufrag of the SDP answer. Optionally, Type accounts for 4 bit, Lengh accounts for 8 bit, 4 bit between Type and Length are reserved, which is convenient for future extension and occupies 2 bytes in total.

S250: feeding back the target signaling response message to the client, to enable the client to detect connectivity based on the redirection address information, and obtain target data corresponding to the signaling request based on a result of detection.

According to the technical solution of the embodiment of the disclosure, the target signaling response message is generated according to the redirection address information and the negotiation address information of the signaling negotiation server, so that the client may obtain the information of the redirection server and obtain the information of the signaling negotiation server. The signaling context is stored in the signaling negotiation server, thus the redirection server may obtain the signaling context from the signaling negotiation server. Further, the data support is provided for establishing the successful connection between the redirection server and the client in the connection detection of the redirection server in the subsequent data phase.

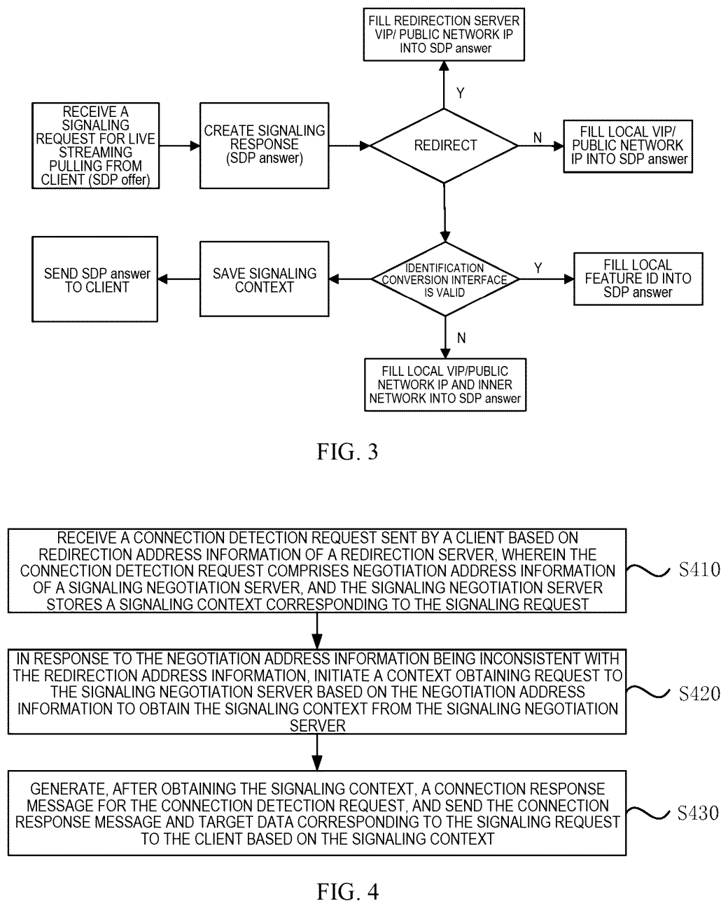

FIG. 3 is a schematic flowchart of a signaling negotiation method in a data communication scenario implemented based on WebRTC according to an embodiment of the present disclosure. As shown in FIG. 3, an execution process of the signaling negotiation method comprises:
1. After receiving the signaling request (SDP offer) of the client, the signaling negotiation server of the server performs signaling negotiation to create an initial signaling response message (SDP answer).
2. The scheduling system of the server determines whether to redirect as needed, and if redirect, the VIP/public network IP of the redirection server is taken as the to-be-filled information that is to be filled into a=candidate row of the SDP answer, otherwise, the (local) VIP/public network IP of the signaling negotiation server is taken as the to-be-filled information that is to be filled into a=candidate row of the SDP answer.
3. The server detects whether the address conversion interface of the public network IP/VIP and the inner network IP of the server is valid according to the second address identification information, and if valid, the local second address identification information is filled into a=ice-ufrag row of the SDP answer, otherwise, the local negotiation address information, i.e., the VIP/public network IP and the inner network IP, is filled into a=ice-ufrag row of the SDP answer.
4. The signaling negotiation server of the server saves the signaling context, and sends the filled target signaling response message SDP answer to the client.
5. After receiving the SDP answer, the client fills the content of a=ice-ufrag row into the USERNAME attribute of connectivity detection request STUN Binding Request, and sends it to the server address specified in a=candidate row in the target signaling response message, performs connectivity detection, and establishes a media channel.

With the technical solution, redirection may be simply and quickly carried out, redirection information may be fed back to the client, and may be applied to subsequent data phases, without dependency on an HTTP protocol, and without a secondary request, a media channel may be established in one signaling request, thus improving the response efficiency of redirection.

FIG. 4 is a schematic flowchart of another data communication method according to an embodiment of the present disclosure. The embodiment of the present disclosure is applicable to a interaction situation in which a signaling request is redirected in a data phase, and is particularly applicable to a distributed system under a load balancing mechanism. The method may be executed by a data communication apparatus, which may be implemented in the form of software and/or hardware, optionally, by an electronic device. The electronic device may be a server or an upper layer management device of the server, or the like.

As shown in FIG. 4, the method in this embodiment may specifically comprise:

S410: receive a connection detection request sent by a client based on redirection address information of a redirection server, wherein the connection detection request comprises negotiation address information of a signaling negotiation server, and the signaling negotiation server stores a signaling context corresponding to the signaling request.

As described above, after receiving the target signaling response message, the client may enter the data phase. The negotiation address information of a signaling negotiation server in the target signaling response message is obtained. A connection detection request is generated based on the negotiation address information, and a connection detection request is initiated to redirection address information in the target signaling response message, so as to send the connection detection request to the redirection server.

S420: in response to the negotiation address information being inconsistent with the redirection address information, initiate a context obtaining request to the signaling negotiation server based on the negotiation address information to obtain the signaling context from the signaling negotiation server.

Optionally, the redirection address information comprises a first virtual service address corresponding to the redirection server, and the negotiation address information comprises a second virtual service address and a first actual service address of the negotiation server. It should be noted that, both the first virtual service address and the second virtual service address may correspond to a plurality of servers, and therefore, may also correspond to actual service addresses of the plurality of servers.

At this time, when the context obtaining request is initiated to the signaling negotiation server based on the negotiation address information, it may first determine whether the first virtual service address is consistent with the second virtual service address are consistent, and whether the actual physical address of the redirection server is consistent with the first actual service address of the negotiation server, and if consistent, it is local, and the signaling context may be directly obtained from the current redirection server.

Optionally, in response to the first virtual service address being consistent with the second virtual service address, the context obtaining request is initiated to the negotiation server based on the first actual service address; and the signaling context that is corresponding to the context obtaining request and fed back by the negotiation server is received.

Optionally, in response to the first virtual service address being inconsistent with the second virtual service address, the context obtaining request is initiated to the second virtual service address; and the signaling context that is corresponding to the context obtaining request and fed back by a response server corresponding to the second virtual service address is received, wherein the response server is a server that receives the context obtaining request.

In practical applications, the response server receiving the context obtaining request may or may not be a signaling negotiation server. Therefore, the second actual service address of the response server may or may not be inconsistent with the first actual service address. Specifically, in response to the second actual service address of the response server being consistent with the first actual service address, the response server is the signaling negotiation server storing the signaling context, and the signaling context may be directly obtained from the response server. In response to the second actual service address of the response server being inconsistent with the first actual service address, the signaling context is obtained by the response server from the signaling negotiation server based on the first actual service address.

Specifically, the context request may be sent to the signaling negotiation server based on the first actual service address via the response server, and then the signaling context fed back by the signaling negotiation server via the response server may be received.

For example, after receiving the connection detection request (STUN Binding Request), the redirection server (local machine) of the server parses the USERNAME attribute in the STUN packet. If the USERNAME stores negotiation address information (for example, the second address identification information) of the signaling negotiation server, at this time it is determined whether the negotiation address information belongs to the local machine, and if yes, the signaling context is directly obtained from the local machine; and if not, the cluster name, the public network IP/VIP and the inner network IP are obtained through negotiation address information. If the USERNAME stores the public network IP/VIP and the inner network IP, the cluster name is parsed by the public network IP/VIP. Then, it is determined whether the obtained cluster name is the cluster in which the local machine is located, if it is the cluster in which the local machine is located and the inner network IP is also local, the signaling context is directly obtained locally, otherwise, the signaling context is requested to the inner network IP. If it is not the cluster in which the local machine is located, the signaling context is requested to the VIP/outer network IP. The response server receiving the signaling context request re-reads the above step of determining whether the negotiation address information belongs to the local machine and following steps, and ends the above procedure after obtaining the signaling context, normally establishes a data communication channel, and provides a data communication service.

If the number of requests for the context request exceeds the predetermined number threshold (for example, 3), or the request duration of the context request exceeds the predetermined duration, it may be considered that the exception occurs, the current signaling request may be terminated, the request failure prompt information is generated, and fed back to the client.

S430: generate, after obtaining the signaling context, a connection response message for the connection detection request, and send the connection response message and target data corresponding to the signaling request to the client based on the signaling context.

The redirection server obtains the signaling context, and may determine the target data requested by the client in the signaling request based on the signaling context. At this time, a connection response message for the connection detection request may be generated and sent to the client. In response that the client receives the detection response message corresponding to the connection detection request and fed back by the redirection server, it is determined that the communication channel is successfully established between the client and the server, to implement data communication with the server. At this time, the target data may be obtained from the server.

For ease of understanding, the description is continued with an example in which a data communication is implemented based on WebRTC. When executing the ICE connection, the client sends a STUN (SessionTraversal Utility for NAT, NAT session traversal application) Binding Request packet to the redirection candidate address in the SDP received at the signaling phase (that is, the outer network IP/VIP indicated by the redirection address information) for connection detection, and the ice-ufrag field of SDP is filled into the USERNAU attribute of the STUN packet. After receiving the STUN Binding Request packet, the redirection server establishing the media channel with the client parses the outer network IP/VIP and the inner network IP in the USERNAME attribute, and locates the server providing the signaling service, obtains the signaling context of the current signaling request through the HTTP request, so as to continue to provide the data transmission service, and realizes the redirection of data communication.

It should be noted that the signaling negotiation server and the redirection server are not limited to the functionality of the server in the cluster, but are used to distinguish the response actions performed by the server in different phases of data communication. In one signaling request, the server allocated in the signaling negotiation phase for responding to the signaling request storage context is referred to as a signaling negotiation server, and the server performing the data phase establishment connection after redirection is referred to as a redirection server. In practical applications, a cluster usually receives a variety of signaling requests. The signaling negotiation server and the redirection server are dynamically allocated when responding to the signaling request, and may be any server in the cluster. In other words, the same server in the cluster may be a signaling negotiation server in a signaling request, and may be a redirection server in another signaling request.

According to the technical solution of the embodiment of the disclosure, firstly, the connection detection request sent by the client based on the redirection address information of the redirection server is received, and the connection detection request comprises the negotiation address information of the signaling negotiation server, the signaling negotiation server stores the signaling context corresponding to the signaling request, so that the connection detection request may be sent to the redirection server, and the storage address of the signaling context of the redirection server may be notified. Then, in response to the negotiation address information being inconsistent with the redirection address information, the context obtaining request is sent to the signaling negotiation server based on the negotiation address information, so that the signaling context is obtained from the signaling negotiation server, and a foundation is laid for the determination of the subsequent target data. Finally, after obtaining the signaling context, a connection response message for the connection detection request is generated, and the connection response message and the target data corresponding to the signaling request are sent to the client based on the signaling context. The communication channel may be established with the redirection server in the data phase, data communication is realized, and the redirection of the data communication is realized in one request, the signaling interaction time in the redirection scene is reduced, and the response efficiency of redirection is improved.

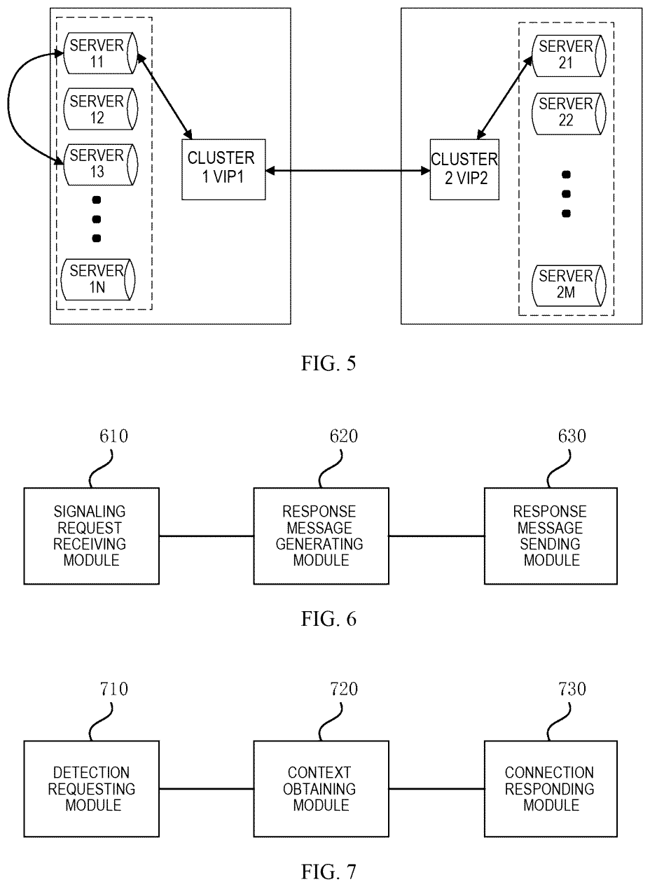

FIG. 5 is a schematic flowchart of another data communication method according to an embodiment of the present disclosure. It is assumed that the signaling negotiation server is the server 13 in the cluster 1, and the negotiation address information is VIP1 and the inner network IP of the server 13. The redirection server is servers 21 in the cluster 2, and the redirection address information of the redirection server is VIP2.

As shown in FIG. 5, the client sends a connection detection request to the server 21 based on VIP2. After receiving the connection detection request, the server 21 parses the negotiation address information corresponding to the signaling negotiation server, that is, VIP1 and the inner network IP of the server 13, and then finds after comparison that the negotiated address information parsed out is VIP1 but not VIP2, that is, the signaling negotiation server is not in the cluster 2. At this time, the redirection server sends context obtaining request to VIP1. The VIP1 may send the context obtaining request to any server in the VIP1. It is assumed that the VIP1 may send the context obtaining request to the server 11, and at this time, the VIP1 and inner network IP corresponding to the server 11 and negotiation address information are compared, that is, the VIP1 and inner network IP of the server 13, and it is found that the signaling negotiation server is not local, and then the server 11 sends the context obtaining request to the slave server 13 according to the inner network IP of the server 13. After receiving the signaling context sent by the server 13, the server 11 feeds back the signaling context to the server 21 of the VIP2.

After obtaining the signaling context, the server 21 sends a message response message corresponding to the connection detection request to the client to implement the communication connection, and may feed back the target data corresponding to the signaling request to the client based on the signaling context.

According to the technical solution provided by the embodiment of the disclosure, signaling sharing among nodes is realized, and redirection of data communication is realized without re-initiating a signaling request.

FIG. 6 is a schematic structural diagram of a signaling negotiation apparatus according to an embodiment of the present disclosure. As shown in FIG. 6, the apparatus comprises: a signaling request receiving module 610, a response message generating module 620, and a response message sending module 630.

The signaling request receiving module 610 is configured to generate, in response to a signaling request sent by a client, a signaling context corresponding to the signaling request, and store the signaling context. The response message generating module 620 is configured to, in response to receiving redirection address information of a redirection server corresponding to the signaling request, generate a target signaling response message based on the redirection address information and negotiation address information of the signaling negotiation server. The response message sending module 630 is configured to feed back the target signaling response message to the client, to enable the client to detect connectivity based on the redirection address information, and obtain target data corresponding to the signaling request based on a result of detection.

According to the technical solution of embodiments of this disclosure, firstly, in response to a signaling request sent by a client, a signaling context corresponding to the signaling request is generated, and the signaling context is stored, therefore feedback data corresponding to the signaling request is determined based on the signaling context. Then, in response to receiving redirection address information of a redirection server corresponding to the signaling request, a target signaling response message is generated based on the redirection address information and negotiation address information of the signaling negotiation serve. The target signaling response message is fed back to the client, to enable the client to detect connectivity based on the redirection address information, and obtain target data corresponding to the signaling request based on a result of detection. The redirection address information and the negotiation address information may be obtained at the same time in one signaling request, so that the connection between the redirection server and the client may be established based on the redirection address information and the negotiation address information in the data phase. That is, the connection with redirection server may be established in one signaling request. The technical problem that in the related art, the redirection function needs to be realized according to a specific protocol and the request response efficiency is reduced due to redirection is solved. Various network protocols may be adapted, the dependency of redirection on a specific protocol is overcome. Further, the application scene of redirection is expanded, and the signaling interaction time in the redirection scene is reduced.

Optionally, the response message generating module 620 comprises: an initial message creation unit, a filling information determination unit and a target message generation unit.

The initial message creation unit is configured to create an initial signaling response message corresponding to the signaling request. The filling information determination unit is configured to determine first address filling information corresponding to the redirection address information and second address filling information corresponding to the negotiation address information of the signaling negotiation server, respectively. The target message generation unit is configured to generate target address filling information based on the first address filling information and the second address filling information, and fill the target address filling information into the initial signaling response message to obtain a target signaling response message.

Optionally, the filling information determination unit comprises an address information encrypting sub-unit and/or an address identification obtaining sub-unit. The address information encrypting sub-unit is configured to encrypt the redirection address information to obtain the first address filling information. The address identification obtaining sub-unit is configured to determine first address identification information corresponding to the redirection address information, and take the first address identification information as the first address filling information.

Optionally, the address identification obtaining sub-unit is specifically configured to:
obtain predetermined first address identification information corresponding to the redirection address information; or
convert the redirection address information into the first address identification information based on a predetermined identification conversion interface.

Further, the filling information determination unit is specifically configured to:
in response to the identification conversion interface being in a valid state, convert the redirection address information into first address identification information based on the identification conversion interface, and take the first address identification information as the first address filling information; and
in response to the identification conversion interface being in an invalid state, encrypt the redirection address information to obtain the first address filling information.

Optionally, the target address filling information comprises candidate address information and target verification information.

Further, the target message generation unit is specifically configured to:
take the first address filling information as candidate address information; and
join the second address filling information and verification association information in a predetermined order to obtain target verification information, wherein the verification association information comprises a validation random number configured to recognize validity of a network communication protocol.

The signaling negotiation apparatus provided in the embodiments of the present disclosure may perform the signaling negotiation method provided in any embodiment of the present disclosure, and has corresponding functional modules and beneficial effects of performing the signaling negotiation method.

It should be noted that the units and modules comprised in the foregoing apparatus are only divided according to the function logic, but are not limited to the foregoing division, as long as the corresponding functions can be implemented. In addition, the specific names of the functional units are merely for ease of distinguishing, and are not intended to limit the protection scope of the embodiments of the present disclosure.

FIG. 7 is a schematic structural diagram of a data communication apparatus according to an embodiment of the present disclosure. As shown in FIG. 7, the apparatus comprises: a detection requesting module 710, a context obtaining module 20 and a connection responding module 730.

The detection requesting module 710 is configured to receive a connection detection request sent by a client based on redirection address information of a redirection server, wherein the connection detection request comprises negotiation address information of a signaling negotiation server, and the signaling negotiation server stores a signaling context corresponding to the signaling request. The context obtaining module 720 is configured to, in response to the negotiation address information being inconsistent with the redirection address information, initiate a context obtaining request to the signaling negotiation server based on the negotiation address information to obtain the signaling context from the signaling negotiation server. The connection responding module 730 is configured to generate, after obtaining the signaling context, a connection response message for the connection detection request, and send the connection response message and target data corresponding to the signaling request to the client based on the signaling context.

According to the technical solution of the embodiment of the disclosure, firstly, the connection detection request sent by the client based on the redirection address information of the redirection server is received, and the connection detection request comprises the negotiation address information of the signaling negotiation server, the signaling negotiation server stores the signaling context corresponding to the signaling request, so that the connection detection request may be sent to the redirection server, and the storage address of the signaling context of the redirection server may be notified. Then, in response to the negotiation address information being inconsistent with the redirection address information, the context obtaining request is sent to the signaling negotiation server based on the negotiation address information, so that the signaling context is obtained from the signaling negotiation server, and a foundation is laid for the determination of the subsequent target data. Finally, after obtaining the signaling context, a connection response message for the connection detection request is generated, and the connection response message and the target data corresponding to the signaling request are sent to the client based on the signaling context. The communication channel may be established with the redirection server in the data phase, data communication is realized, and the redirection of the data communication is realized in one request, the signaling interaction time in the redirection scene is reduced, and the response efficiency of redirection is improved.

Optionally, the redirection address information comprises a first virtual service address, and the negotiation address information comprises a second virtual service address and a first actual service address of the negotiation server. Accordingly, the context obtaining module 720 is specifically configured to:
in response to the first virtual service address being consistent with the second virtual service address, initiate the context obtaining request to the negotiation server based on the first actual service address; and
receive the signaling context that is corresponding to the context obtaining request and fed back by the negotiation server.

Optionally, the redirection address information comprises a first virtual service address, and the negotiation address information comprises a second virtual service address and a first actual service address of the negotiation server. Accordingly, the context obtaining module 720 is specifically, configured to:
in response to the first virtual service address being inconsistent with the second virtual service address, initiate the context obtaining request to the second virtual service address; and
receive the signaling context that is corresponding to the context obtaining request and fed back by a response server corresponding to the second virtual service address, wherein the response server is a server that receives the context obtaining request.

Optionally, in response to the second actual service address being inconsistent with the first actual service address, the signaling context is obtained by the response server from the signaling negotiation server based on the first actual service address.

The data communication apparatus provided in the embodiments of the present disclosure may perform the data communication method provided in any embodiment of the present disclosure, and has corresponding functional modules and beneficial effects of performing the data communication method.

It should be noted that the units and modules comprised in the foregoing apparatus are only divided according to the function logic, but are not limited to the foregoing division, as long as the corresponding functions can be implemented. In addition, the specific names of the functional units are merely for ease of distinguishing, and are not intended to limit the protection scope of the embodiments of the present disclosure.

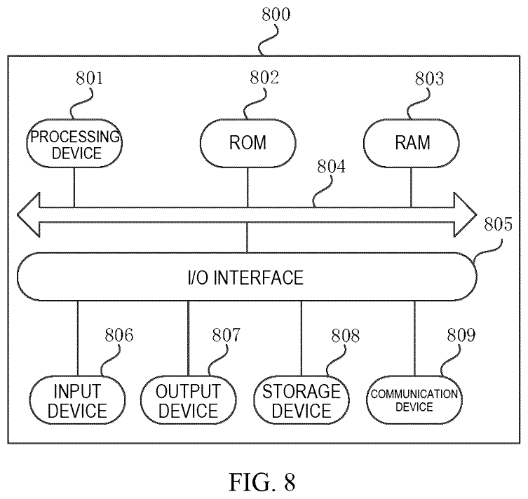

FIG. 8 is a schematic structural diagram of an electronic device according to an embodiment of this disclosure. Reference now is made with FIG. 8, which is a schematic structural diagram of an electronic device (such as the terminal device or server in FIG. 8) suitable for implementing the embodiments of the disclosure. The terminal device in the embodiments of the disclosure may comprise, but not limited to, a mobile terminal such as a mobile phone, a notebook computer, a digital broadcast receiver, a PDA (personal digital assistant), a PAD (portable Android device), a PMP (portable media player), an in-vehicle terminal (for example, an in-vehicle navigation terminal), and a fixed terminal such as a digital TV, a desktop computer, or the like. The electronic device shown in FIG. 8 is merely an example, and should not impose any limitation on the functionality and scope of use of the embodiments of the disclosure.

As shown in FIG. 8, the electronic device 800 may include a processing device (for example, a central processing unit, a graphics processor, etc.) 801, and the processing device 801 may perform various appropriate actions and processing according to a program stored in a read-only memory (ROM) 802 or a program loaded into a random access memory (RAM) 803 from a storage device 808. In the RAM 803, various programs and data required by the operation of the electronic device 800 are also stored. The processing device 801, the ROM 802, and the RAM 808 are connected to each other through a bus 804. An input/output (I/O) interface 805 is also connected to the bus 804.

Generally, the following devices may be connected to the I/O interface 805: an input device 806 including, for example, a touch screen, a touch pad, a keyboard, a mouse, a camera, a microphone, an accelerometer, a gyroscope, and the like; an output device 807 including, for example, a liquid crystal display (LCD), a speaker, a vibrator, and the like; a storage device 808 including, for example, a magnetic tape, a hard disk, and the like; and a communication device 809. The communication device 809 may allow the electronic device 800 to communicate wirelessly or wired with other devices to exchange data. While FIG. 8 shows an electronic device 800 having various devices, it should be understood that it is not required to implement or have all illustrated devices. More or fewer devices may alternatively be implemented or provided.

In particular, according to an embodiment of this disclosure, the process described above with reference to the flowchart may be implemented as a computer software program. For example, embodiments of the disclosure comprise a computer program product comprising a computer program embodied on a non-transitory computer readable medium, the computer program comprising program code for performing a method shown in flowchart. In such embodiments, the computer program may be downloaded and installed from the network through the communication device 809, or installed from the storage device 808, or from the ROM 802. When the computer program is executed by the processing device 801, the foregoing functions defined in the method of the embodiments of the present disclosure are performed.

The names of messages or information interacted between a plurality of devices in embodiments of the present disclosure are for illustrative purposes only, and are not intended to limit the scope of such messages or information.

The electronic device provided by the embodiments of the disclosure and the data communication method provided in the foregoing embodiments belong to the same inventive concept, and technical details not described in detail in this embodiment may refer to the foregoing embodiments, and this embodiment has the same beneficial effects as the foregoing embodiments.

An embodiment of the present disclosure provides a computer storage medium, having a computer program stored thereon, where the computer program, when executed by a processor, implements the signaling negotiation method and/or the data communication method provided in the foregoing embodiments.

It should be noted that the computer readable medium described above may be a computer readable signal medium, or a computer readable storage medium, or a combination of the both. The computer-readable storage medium may be, for example, but not limited to, an electrical, magnetic, optical, electromagnetic, infrared, or semiconductor system, apparatus, or device, or a combination thereof. Examples of the computer-readable storage medium may comprise, but not limited to: an electrical connection having one or more wires, a portable computer diskette, a hard disk, a random access memory (RAM), a read-only memory (ROM), an erasable programmable read-only memory (such as an electronic programmable read-only memory (EPROM) or flash memory), an optical fiber, a portable compact disc read-only memory (CD-ROM), an optical storage device, a magnetic storage device, or a suitable combination thereof. In the disclosure, a computer-readable storage medium may be a tangible medium containing or storing a program that may be used by or in connection with an instruction execution system, apparatus, or device. In the disclosure, a computer readable signal medium may comprise a data signal propagated in baseband or as part of a carrier, where the computer readable program code is carried. Such propagated data signals may take a variety of forms, comprising but not limited to electromagnetic signals, optical signals, or suitable combinations thereof. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, comprising but not limited to wires, optical cables, RF (radio frequency), and the like, or suitable combinations thereof.

In some implementations, the client, server may communicate using any currently known or future developed network protocol, such as Hypertext Transfer Protocol (HTTP), and may be interconnected with any form or medium of digital data communication (e.g., a communication network). Examples of communication networks include Local Area Networks (LANs), Wide Area Networks (WANs), Internet networks (e.g., the Internet), and peer-to-peer networks (e.g., ad hoc peer-to-peer networks), as well as currently known or future developed networks.

The computer-readable medium described above may be comprised in the electronic device; or may be separately present without being assembled into the electronic device.

The computer readable medium carries one or more programs, and when one or more programs is executed by the electronic device, the electronic device is caused to: generate, in response to a signaling request sent by a client, a signaling context corresponding to the signaling request, and store the signaling context; in response to receiving redirection address information of a redirection server corresponding to the signaling request, generate a target signaling response message based on the redirection address information and negotiation address information of the signaling negotiation server; and feed back the target signaling response message to the client, to enable the client to detect connectivity based on the redirection address information, and obtain target data corresponding to the signaling request based on a result of detection.

In addition, the computer readable medium carries one or more programs, and when one or more programs is executed by the electronic device, the electronic device is caused to: receive a connection detection request sent by a client based on redirection address information of a redirection server, wherein the connection detection request comprises negotiation address information of a signaling negotiation server, and the signaling negotiation server stores a signaling context corresponding to the signaling request; in response to the negotiation address information being inconsistent with the redirection address information, initiate a context obtaining request to the signaling negotiation server based on the negotiation address information to obtain the signaling context from the signaling negotiation server; and generate, after obtaining the signaling context, a connection response message for the connection detection request, and send the connection response message and target data corresponding to the signaling request to the client based on the signaling context.

Computer program code for performing the operations of the present disclosure may be written in one or more programming languages, including, but not limited to, object-oriented programming languages such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of a remote computer involved, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that comprises one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of the module does not constitute a limitation on the unit itself in some cases. For example, the first obtaining unit may be described as “a unit that obtains at least two Internet Protocol addresses”.

The functions described above may be performed, at least in part, by one or more hardware logic components. For example, without limitation, exemplary types of hardware logic components that may be used comprise: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The server-readable medium may be a server-readable signal medium or a server-readable storage medium. The server-readable medium may comprise electronic, magnetic, optical, electromagnetic, infrared, or semiconductor systems, apparatus, or devices, or any suitable combination of the foregoing. The examples of server-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of this disclosure, Example 1 provides a signaling negotiation method, comprising:
generating, in response to a signaling request sent by a client, a signaling context corresponding to the signaling request, and storing the signaling context;
in response to receiving redirection address information of a redirection server corresponding to the signaling request, generating a target signaling response message based on the redirection address information and negotiation address information of the signaling negotiation server; and
feeding back the target signaling response message to the client, to enable the client to detect connectivity based on the redirection address information, and obtain target data corresponding to the signaling request based on a result of detection.

According to one or more embodiments of this disclosure, Example 2 provides the method of Example 1, further comprises:

Optionally, generating the target signaling response message based on the redirection address information and the negotiation address information of the signaling negotiation server comprises:
creating an initial signaling response message corresponding to the signaling request;
determining first address filling information corresponding to the redirection address information and second address filling information corresponding to the negotiation address information of the signaling negotiation server, respectively; and
generating target address filling information based on the first address filling information and the second address filling information, and filling the target address filling information into the initial signaling response message to obtain a target signaling response message.

According to one or more embodiments of this disclosure, Example 3 provides the method of Example 2, further comprises:
encrypting the redirection address information to obtain the first address filling information; and/or
determining first address identification information corresponding to the redirection address information, and taking the first address identification information as the first address filling information.

According to one or more embodiments of this disclosure, Example 4 provides the method of Example 3, further comprises:

Optionally, the determining the first address identification information corresponding to the redirection address information comprises:
obtaining predetermined first address identification information corresponding to the redirection address information; or
converting the redirection address information into the first address identification information based on a predetermined identification conversion interface.

According to one or more embodiments of this disclosure, Example 5 provides the method of Example 4, further comprises:

Optionally, determining the first address filling information corresponding to the redirection address information comprises:
in response to the identification conversion interface being in a valid state, converting the redirection address information into first address identification information based on the identification conversion interface, and taking the first address identification information as the first address filling information; and
in response to the identification conversion interface being in an invalid state, encrypting the redirection address information to obtain the first address filling information.

According to one or more embodiments of this disclosure, Example 6 provides the method of Example 2, further comprises:
Optionally, the target address filling information comprises candidate address information and target verification information;
generating the target address filling information based on the first address filling information and the second address filling information comprises:
taking the first address filling information as candidate address information; and
joining the second address filling information and verification association information in a predetermined order to obtain target verification information, wherein the verification association information comprises a validation random number configured to recognize validity of a network communication protocol.

According to one or more embodiments of this disclosure, Example 7 provides a data communication method, comprising:
Optionally, receiving a connection detection request sent by a client based on redirection address information of a redirection server, wherein the connection detection request comprises negotiation address information of a signaling negotiation server, and the signaling negotiation server stores a signaling context corresponding to the signaling request;
in response to the negotiation address information being inconsistent with the redirection address information, initiating a context obtaining request to the signaling negotiation server based on the negotiation address information to obtain the signaling context from the signaling negotiation server; and
generating, after obtaining the signaling context, a connection response message for the connection detection request, and sending the connection response message and target data corresponding to the signaling request to the client based on the signaling context.

According to one or more embodiments of this disclosure, Example 8 provides the method of Example 7, further comprises:
Optionally, the redirection address information comprises a first virtual service address, and the negotiation address information comprises a second virtual service address and a first actual service address of the negotiation server;
initiating the context obtaining request to the signaling negotiation server based on the negotiation address information to obtain the signaling context from the signaling negotiation server comprises:
in response to the first virtual service address being consistent with the second virtual service address, initiating the context obtaining request to the negotiation server based on the first actual service address; and
receiving the signaling context that is corresponding to the context obtaining request and fed back by the negotiation server.

According to one or more embodiments of this disclosure, Example 9 provides the method of Example 7, further comprises:
Optionally, the redirection address information comprises a first virtual service address, and the negotiation address information comprises a second virtual service address and a first actual service address of the negotiation server;
initiating the context obtaining request to the signaling negotiation server based on the negotiation address information to obtain the signaling context from the signaling negotiation server comprises:
in response to the first virtual service address being inconsistent with the second virtual service address, initiating the context obtaining request to the second virtual service address; and
receiving the signaling context that is corresponding to the context obtaining request and fed back by a response server corresponding to the second virtual service address, the response server being a server that receives the context obtaining request.

According to one or more embodiments of this disclosure, Example 10 provides the method of Example 9, further comprises:

Optionally, in response to the second actual service address being inconsistent with the first actual service address, the signaling context is obtained by the response server from the signaling negotiation server based on the first actual service address.

According to one or more embodiments of this disclosure, Example 10 provides a signaling negotiation apparatus, comprising:
a signaling request receiving module configured to generate, in response to a signaling request sent by a client, a signaling context corresponding to the signaling request, and store the signaling context;
a response message generating module configured to, in response to receiving redirection address information of a redirection server corresponding to the signaling request, generate a target signaling response message based on the redirection address information and negotiation address information of the signaling negotiation server; and
a response message sending module configured to feed back the target signaling response message to the client, to enable the client to detect connectivity based on the redirection address information, and obtain target data corresponding to the signaling request based on a result of detection.

According to one or more embodiments of this disclosure, Example 12 provides a data communication apparatus, comprising:
a detection requesting module configured to receive a connection detection request sent by a client based on redirection address information of a redirection server, the connection detection request comprising negotiation address information of a signaling negotiation server, and the signaling negotiation server storing a signaling context corresponding to the signaling request;
a context obtaining module configured to, in response to the negotiation address information being inconsistent with the redirection address information, initiate a context obtaining request to the signaling negotiation server based on the negotiation address information to obtain the signaling context from the signaling negotiation server; and
a connection responding module configured to generate, after obtaining the signaling context, a connection response message for the connection detection request, and send the connection response message and target data corresponding to the signaling request to the client based on the signaling context.

The above description is merely an illustration of the preferred embodiments of the present disclosure and the principles of the applied technology. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the technical solution formed by mutually replacing the above features and the technical features have similar functions disclosed (but not limited to) in the present disclosure.

Further, while operations are depicted in a particular order, this should not be understood to require that these operations be performed in the particular order shown or in sequential order. In certain circumstances, multitasking and parallel processing may be advantageous. Likewise, while several specific implementation details are comprised in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A signaling negotiation method, applied to a signaling negotiation server, comprising:
generating, in response to a signaling request sent by a client, a signaling context corresponding to the signaling request, and storing the signaling context;
in response to receiving redirection address information of a redirection server corresponding to the signaling request, generating a target signaling response message based on the redirection address information and negotiation address information of the signaling negotiation server; and
feeding back the target signaling response message to the client, to enable the client to detect connectivity based on the redirection address information, and obtain target data corresponding to the signaling request based on a result of detection.

2. The signaling negotiation method of claim 1, wherein generating the target signaling response message based on the redirection address information and the negotiation address information of the signaling negotiation server comprises:
creating an initial signaling response message corresponding to the signaling request;
determining first address filling information corresponding to the redirection address information and second address filling information corresponding to the negotiation address information of the signaling negotiation server, respectively; and
generating target address filling information based on the first address filling information and the second address filling information, and filling the target address filling information into the initial signaling response message to obtain a target signaling response message.

3. The signaling negotiation method of claim 2, wherein determining the first address filling information corresponding to the redirection address information comprises:
encrypting the redirection address information to obtain the first address filling information; and/or
determining first address identification information corresponding to the redirection address information, and taking the first address identification information as the first address filling information.

4. The signaling negotiation method of claim 3, wherein the determining the first address identification information corresponding to the redirection address information comprises:
obtaining predetermined first address identification information corresponding to the redirection address information; or
converting the redirection address information into the first address identification information based on a predetermined identification conversion interface.

5. The signaling negotiation method of claim 4, wherein determining the first address filling information corresponding to the redirection address information comprises:
in response to the identification conversion interface being in a valid state, converting the redirection address information into first address identification information based on the identification conversion interface, and taking the first address identification information as the first address filling information; and
in response to the identification conversion interface being in an invalid state, encrypting the redirection address information to obtain the first address filling information.

6. The signaling negotiation method of claim 2, wherein the target address filling information comprises candidate address information and target verification information;
generating the target address filling information based on the first address filling information and the second address filling information comprises:
taking the first address filling information as candidate address information; and
joining the second address filling information and verification association information in a predetermined order to obtain target verification information, wherein the verification association information comprises a validation random number configured to recognize validity of a network communication protocol.

7. A data communication method, applied to a redirection server, comprising:
receiving a connection detection request sent by a client based on redirection address information of a redirection server, wherein the connection detection request comprises negotiation address information of a signaling negotiation server, and the signaling negotiation server stores a signaling context corresponding to the signaling request;
in response to the negotiation address information being inconsistent with the redirection address information, initiating a context obtaining request to the signaling negotiation server based on the negotiation address information to obtain the signaling context from the signaling negotiation server; and
generating, after obtaining the signaling context, a connection response message for the connection detection request, and sending the connection response message and target data corresponding to the signaling request to the client based on the signaling context.

8. The data communication method of claim 7, wherein the redirection address information comprises a first virtual service address, and the negotiation address information comprises a second virtual service address and a first actual service address of the negotiation server;
initiating the context obtaining request to the signaling negotiation server based on the negotiation address information to obtain the signaling context from the signaling negotiation server comprises:
in response to the first virtual service address being consistent with the second virtual service address, initiating the context obtaining request to the negotiation server based on the first actual service address; and
receiving the signaling context that is corresponding to the context obtaining request and fed back by the negotiation server.

9. The data communication method of claim 7, wherein the redirection address information comprises a first virtual service address, and the negotiation address information comprises a second virtual service address and a first actual service address of the negotiation server;
initiating the context obtaining request to the signaling negotiation server based on the negotiation address information to obtain the signaling context from the signaling negotiation server comprises:
in response to the first virtual service address being inconsistent with the second virtual service address, initiating the context obtaining request to the second virtual service address; and
receiving the signaling context that is corresponding to the context obtaining request and fed back by a response server corresponding to the second virtual service address, the response server being a server that receives the context obtaining request.

10. The data communication method of claim 9, wherein, in response to the second actual service address being inconsistent with the first actual service address, the signaling context is obtained by the response server from the signaling negotiation server based on the first actual service address.

11. An electronic device, comprising:
one or more processors; and
a storage device storing one or more programs,
the one or more programs, when executed by the one or more processors, causing the one or more processors implement a signaling negotiation method and/or a data communication method,
wherein the signaling negotiation method comprises:
generating, in response to a signaling request sent by a client, a signaling context corresponding to the signaling request, and storing the signaling context;
in response to receiving redirection address information of a redirection server corresponding to the signaling request, generating a target signaling response message based on the redirection address information and negotiation address information of the signaling negotiation server; and
feeding back the target signaling response message to the client, to enable the client to detect connectivity based on the redirection address information, and obtain target data corresponding to the signaling request based on a result of detection; and
wherein the data communication method comprises:
receiving a connection detection request sent by a client based on redirection address information of a redirection server, wherein the connection detection request comprises negotiation address information of a signaling negotiation server, and the signaling negotiation server stores a signaling context corresponding to the signaling request;
in response to the negotiation address information being inconsistent with the redirection address information, initiating a context obtaining request to the signaling negotiation server based on the negotiation address information to obtain the signaling context from the signaling negotiation server; and
generating, after obtaining the signaling context, a connection response message for the connection detection request, and sending the connection response message and target data corresponding to the signaling request to the client based on the signaling context.

12. The electronic device of claim 11, wherein generating the target signaling response message based on the redirection address information and the negotiation address information of the signaling negotiation server comprises:
creating an initial signaling response message corresponding to the signaling request;
determining first address filling information corresponding to the redirection address information and second address filling information corresponding to the negotiation address information of the signaling negotiation server, respectively; and
generating target address filling information based on the first address filling information and the second address filling information, and filling the target address filling information into the initial signaling response message to obtain a target signaling response message.

13. The electronic device of claim 12, wherein determining the first address filling information corresponding to the redirection address information comprises:
encrypting the redirection address information to obtain the first address filling information; and/or
determining first address identification information corresponding to the redirection address information, and taking the first address identification information as the first address filling information.

14. The electronic device of claim 13, wherein the determining the first address identification information corresponding to the redirection address information comprises:
obtaining predetermined first address identification information corresponding to the redirection address information; or
converting the redirection address information into the first address identification information based on a predetermined identification conversion interface.

15. The electronic device of claim 14, wherein determining the first address filling information corresponding to the redirection address information comprises:
in response to the identification conversion interface being in a valid state, converting the redirection address information into first address identification information based on the identification conversion interface, and taking the first address identification information as the first address filling information; and
in response to the identification conversion interface being in an invalid state, encrypting the redirection address information to obtain the first address filling information.

16. The electronic device of claim 12, wherein the target address filling information comprises candidate address information and target verification information;
generating the target address filling information based on the first address filling information and the second address filling information comprises:
taking the first address filling information as candidate address information; and
joining the second address filling information and verification association information in a predetermined order to obtain target verification information, wherein the verification association information comprises a validation random number configured to recognize validity of a network communication protocol.

17. The electronic device of claim 11, wherein the redirection address information comprises a first virtual service address, and the negotiation address information comprises a second virtual service address and a first actual service address of the negotiation server;
initiating the context obtaining request to the signaling negotiation server based on the negotiation address information to obtain the signaling context from the signaling negotiation server comprises:
in response to the first virtual service address being consistent with the second virtual service address, initiating the context obtaining request to the negotiation server based on the first actual service address; and
receiving the signaling context that is corresponding to the context obtaining request and fed back by the negotiation server.

18. The electronic device of claim 11, wherein the redirection address information comprises a first virtual service address, and the negotiation address information comprises a second virtual service address and a first actual service address of the negotiation server;
initiating the context obtaining request to the signaling negotiation server based on the negotiation address information to obtain the signaling context from the signaling negotiation server comprises:
in response to the first virtual service address being inconsistent with the second virtual service address, initiating the context obtaining request to the second virtual service address; and
receiving the signaling context that is corresponding to the context obtaining request and fed back by a response server corresponding to the second virtual service address, the response server being a server that receives the context obtaining request.

19. The electronic device of claim 13, wherein, in response to the second actual service address being inconsistent with the first actual service address, the signaling context is obtained by the response server from the signaling negotiation server based on the first actual service address.

20. The electronic device of claim 17, wherein the first virtual service address and the second virtual service address correspond to actual service addresses of the plurality of servers.
